(19) United States
(12) Patent Application Publication
(10) Pub. No.: US 2020/0199990 A1
(43) Pub. Date: Jun. 25, 2020

(54) PORTABLE CONVEYING APPARATUS FOR TRANSFERRING PROPPANT FROM STORAGE CONTAINER TO BLENDER IN A HYDRAULIC FRACTURING OPERATION

(71) Applicant: Hi-Crush Canada Inc., Houston, TX (US)

(72) Inventor: Henry Friesen, Winkler (CA)

(21) Appl. No.: 16/227,020

(22) Filed: Dec. 20, 2018

(51) Int. Cl. E21B 43/267; E21B 21/06; B01F 15/02; B65D 88/30

(52) U.S. Cl. CPC E21B 43/267; E21B 21/062; B01F 2215/0081; B65D 88/30; B01F 15/0229

(57) ABSTRACT

A portable conveying apparatus for use in a hydraulic fracturing operation to transfer proppant from one or more storage containers storing said proppant to a blender where the proppant is prepared for subsequent delivery to a hydraulic fracturing wellbore comprises a frame, a conveyor supported on the frame and operable to transfer the proppant from a conveyor intake communicated with a storage container to a conveyor discharge communicated with the blender, a control system which is operatively coupled to the conveyor for controlling the conveyor to transfer the proppant therealong, and an operator cab mounted on the frame so as to be portable therewith for housing an operator using the control system to operate the conveyor. The operator cab is arranged to restrict passage of outside air into the operator cab and also so that an interior of the blender is visible to the operator when located therein.

### FIELD OF THE INVENTION

The present invention relates to a portable conveying apparatus for transferring proppant from a storage container to a blender in a hydraulic fracturing operation.

### BACKGROUND

Silicosis is a health hazard for workers exposed to silica dust at hydraulic fracturing operation sites, to which increasing awareness is being drawn. In the portion of the hydraulic fracturing operation where proppant is transferred from a storage container to a blender, where the proppant is prepared for subsequent delivery to a wellbore at the site, a worker is conventionally required to visually observe the blender and adjust operation of a conveyor feeding the proppant to the blender, so as to achieve a desired proppant mixture at the blender. Most often this worker is situated in the ambient environment where exposure to silica dust is probable. A considerable portion of the silica dust is emitted from a transfer point of the proppant from the discharge of the conveyor positioned to the blender.

### SUMMARY OF THE INVENTION

According to an aspect of the invention there is provided a portable conveying apparatus for use in a hydraulic fracturing operation to transfer proppant from one or more storage containers storing said proppant to a blender where the proppant is prepared for subsequent delivery to a hydraulic fracturing wellbore, in combination with the one or more storage containers and the blender, the portable conveying apparatus comprising:

a frame;

a plurality of wheels mounted on the frame for rotation about respective wheel axes so as to support the frame in movement across a ground surface;

a hitch coupling attached to the frame so that the frame is towable across the ground surface by a transport vehicle;

a conveyor supported on the frame and having a conveying member driven to transfer the proppant from an intake of the conveyor to a discharge of the conveyor, the intake being operatively communicated with the one or more storage containers to receive the proppant therefrom and the discharge of the conveyor being communicated with the blender so as to transfer the proppant to the blender;

a control system which is operatively coupled to the conveyor for controlling the conveying member to transfer the proppant from the intake to the discharge;

an operator cab mounted on the frame so as to be portable therewith for housing an operator using the control system to operate the conveying member;

the operator cab being arranged so that an interior of the blender where the proppant is prepared is visible to the operator when located therein;

the operator cab including:
a floor;
a peripheral wall standing upwardly from the floor;
a ceiling closing a top of the peripheral wall;
a door arranged so to define a selectively openable entryway into the operator cab to enable the operator to pass from outside the operator cab into the operator cab;
a window mounted in the peripheral wall in a manner so that the interior of the blender is visible from inside the operator cab;
whereby the floor, the peripheral wall, the ceiling and the door of the operator cab collectively form a substantially enclosed space which restricts passage of air outside the operator cab into the operator cab;

the operator cab including an air filtration system adapted to permit passage of air which is free of silica dust between the outside and the inside of the operator cab;

the operator cab further including a controller of the control system located in the substantially enclosed space for interfacing with the control system to operate the conveying member.

The foregoing arrangement provides a work environment for the operator which is substantially free of silica dust at a location from which the operator can still visually observe the blender.

Preferably the air filtration system also is adapted to pressurize the operator cab to form an air pressure gradient between the inside and the outside of the operator cab with greater air pressure inside the operator cab than outside of the operator cab so as to be suited for expelling particulate material out of the operator cab.

Typically the frame which carries the conveyor has longitudinally opposite ends and laterally opposite sides.

The window may be located at a laterally offset location from a lateral position of the discharge of the conveyor relative to the frame.

The cab may be located at a laterally offset location from a lateral position of the discharge of the conveyor relative to the frame.

In one arrangement, the discharge of the conveyor is located generally laterally centrally of the frame and the operator cab which is smaller in width than a width of the frame between the laterally opposite sides thereof is located closer to one of the lateral sides of the frame than the other.

Typically the hitch coupling is located at a front one of the ends of the frame and the discharge is located at a rear one of the ends of the frame, and preferably the operator cab is located on the frame at a longitudinally spaced position from the rear end of the frame.

In such an arrangement, preferably the floor of the operator cab is spaced above the frame and arranged at a suitable height for the operator standing thereon to see over the frame and beyond the rear end of the frame.

In one arrangement, the operator cab is defined by a kit of assemblable parts which are connectable to the frame of the portable conveying apparatus which was originally manufactured at a manufacturing facility without the operator cab, and therefore previously excluded the operator cab.

The operator cab may further include an externally mounted spotlight which is oriented so as to illuminate the interior of the blender.

The spotlight may be mounted at a laterally offset location from a lateral position of the discharge of the conveyor relative to the frame.

### BRIEF DESCRIPTION OF THE DRAWINGS

The invention will now be described in conjunction with the accompanying drawings in which:

FIG. 1 is an elevational view of an arrangement of portable conveying apparatus according to the present invention;

FIG. 2A is a perspective view of the arrangement of FIG. 1 in an operating environment of a hydraulic fracturing operation including a plurality of storage containers and a blender;

FIG. 2B is a top plan view of the arrangement of FIG. 1 in its operating environment as shown in FIG. 2A;

FIG. 3 is a side elevation view of a portion of the arrangement of FIG. 1 but taken from an opposite side from that shown in FIG. 1, showing more clearly an operator cab of the arrangement of portable conveying apparatus;

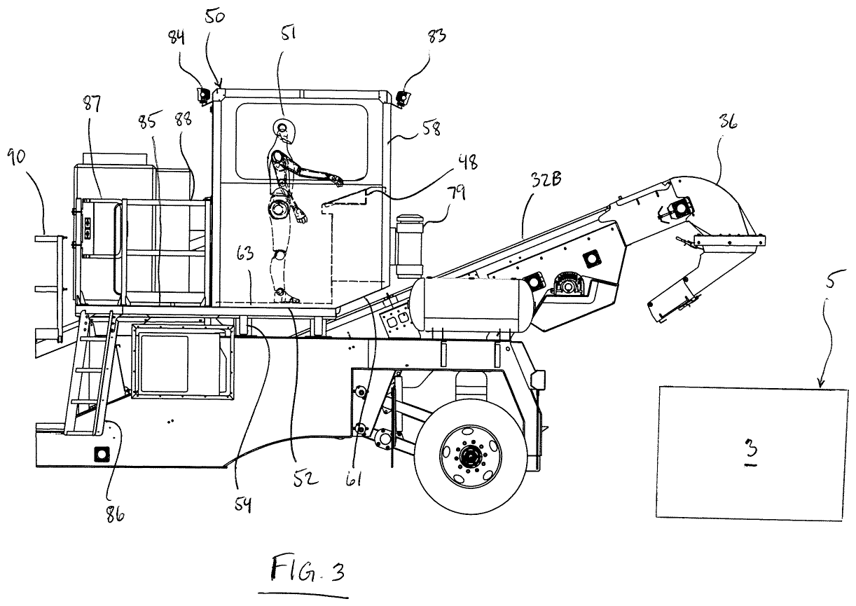

FIG. 4 is a top plan view of the portion of the arrangement of portable conveying apparatus that is shown in FIG. 3;

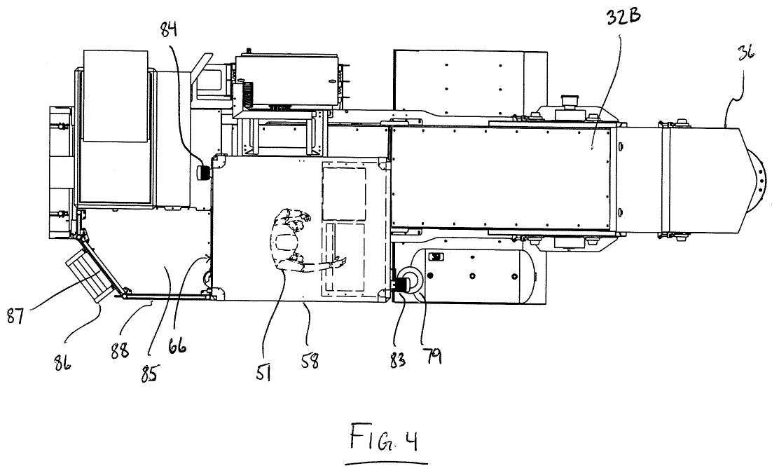

FIG. 5 is an end elevational view of the arrangement of FIG. 1 with some components omitted for clarity and convenience of illustration;

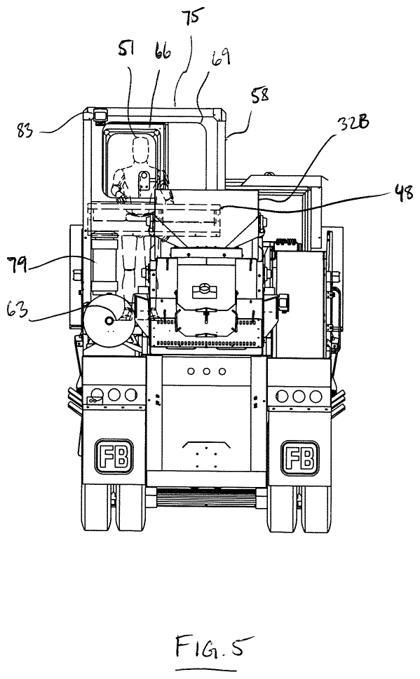

FIG. 6 is a perspective view of an assembled kit of the operator cab of the arrangement of FIG. 1;

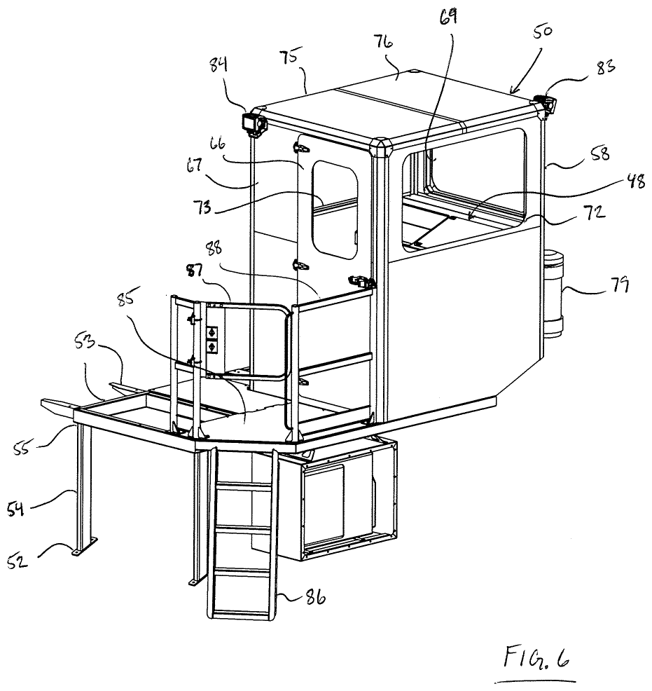

FIG. 7 is an elevational view of the assembled kit of FIG. 6; and

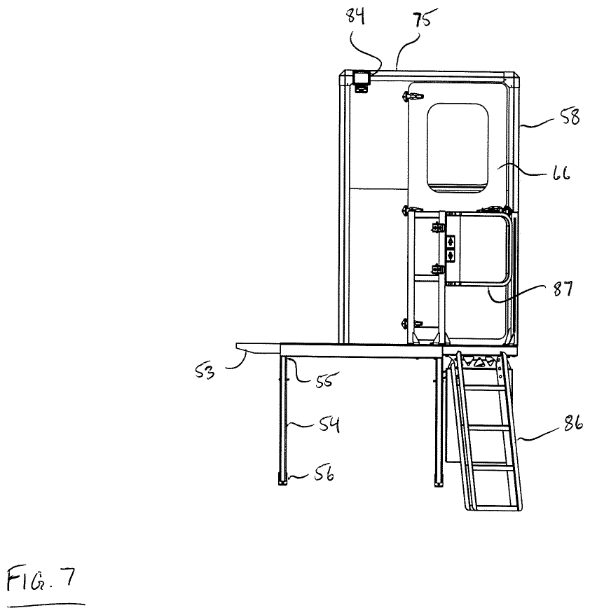

FIG. 8 is a top plan view of the assembled kit of FIG. 6.

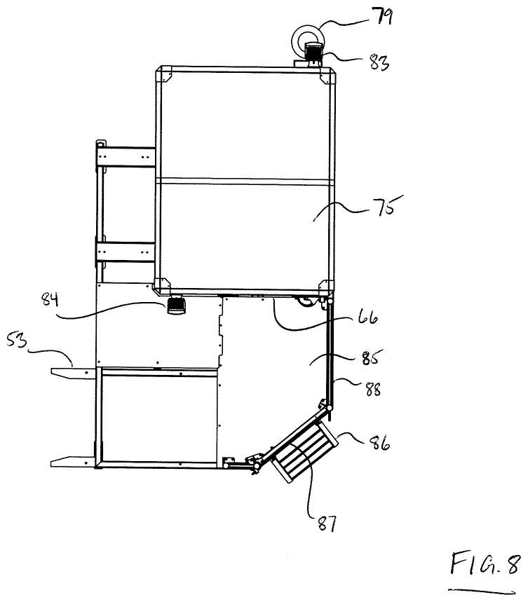

In the drawings like characters of reference indicate corresponding parts in the different figures.

### DETAILED DESCRIPTION

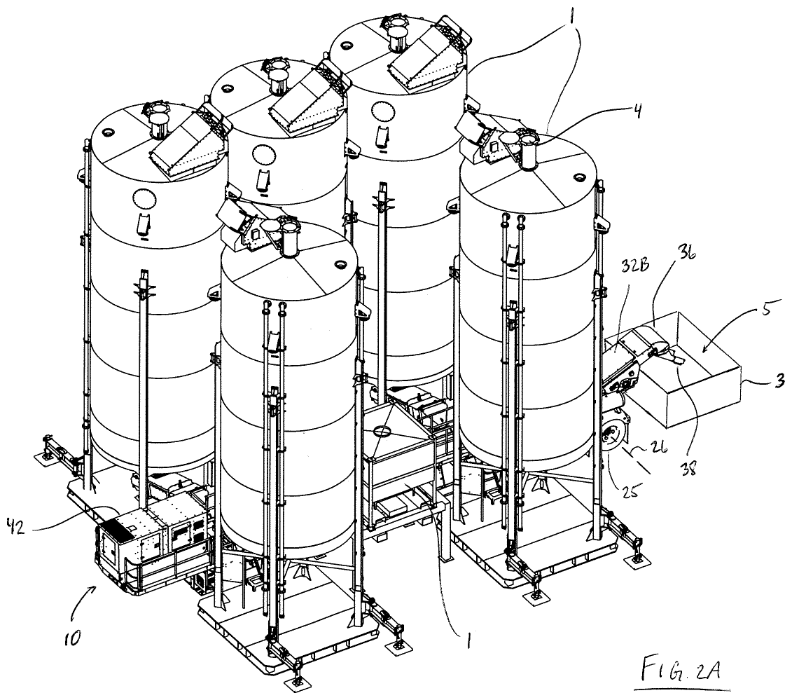

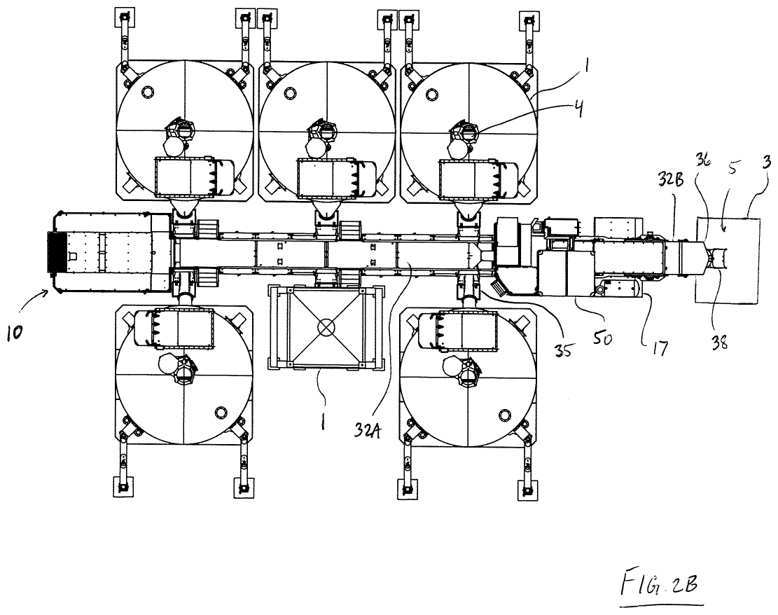

The accompanying figures show a portable conveying apparatus 10 for use in a hydraulic fracturing operation to transfer proppant from one or more storage containers 1 (FIGS. 2A and 2B) storing the proppant to a blender 3 (schematically shown) where the proppant is prepared for subsequent delivery to a hydraulic fracturing wellbore (not shown). Typically, the storage containers 1 are positioned in an array at a site of the hydraulic fracturing operation, and a feed conveyor such as that at 10 which transfers the proppant from these containers to the blender 3 is positioned within a footprint of the array, that is between the storage containers 1, so that the feed conveyor can be simultaneously communicated with a plurality of storage containers 1. The storage containers 1 may be in the form of portable silos which are filled on-site pneumatically or by a conveyor which is arranged to fill the silos via their top fill openings 4, or in the form of pre-filled containers which are loaded with proppant at a remote location from the hydraulic fracturing operation and transported in an already-filled state for use in forming the appropriate mixture at the blender 3. The blender 3 is typically located adjacent the array of storage containers 1.

The blender 3 is a mixing apparatus comprising a bin defining an interior 5 of the blender where the mixing of the proppant with other fluids such as water and chemicals takes place. The blender may be mounted on a trailer or a truck so as to be portable from one site to the next. Typically the blender 3 also includes high pressure pumps defining at least in part a proppant-to-wellbore delivery arrangement for delivering and injecting the prepared proppant mixture into the wellbore after the mixing or blending process.

The portable conveying apparatus 10 comprises a trailer frame 11 of the type for towing on a highway by a highway tractor. The trailer frame 11 has a center frame section 12, a rear frame section 13 coupled at a rear 15 of the center frame section 12 and defining a rear end 17 of the trailer frame, and a forward frame section 18 coupled at a front 20 of the center frame section and defining a forward end 21 of the trailer frame that is longitudinally opposite the rear end 17. The center frame section 12 is lowered relative to both the forward frame section 18 and the rear frame section 13.

A wheel and axle assembly 24 is mounted to the rear frame section 13 to support the apparatus 10 in movement across a ground surface G, and thus the apparatus 10 includes a plurality of wheels 25 mounted on the frame 11 for rotation about respective wheel axes 26 so as to support the frame 11 in movement across the ground surface. A hitch coupling in the form of a downwardly depending king pin 27 is mounted to an underside of the forward frame section 18, so as to be located at the front end of the frame, so that the trailer frame 11 can be coupled to a transport vehicle for towing across the ground surface, or more generally for transport of the apparatus 10 from one location to the next.

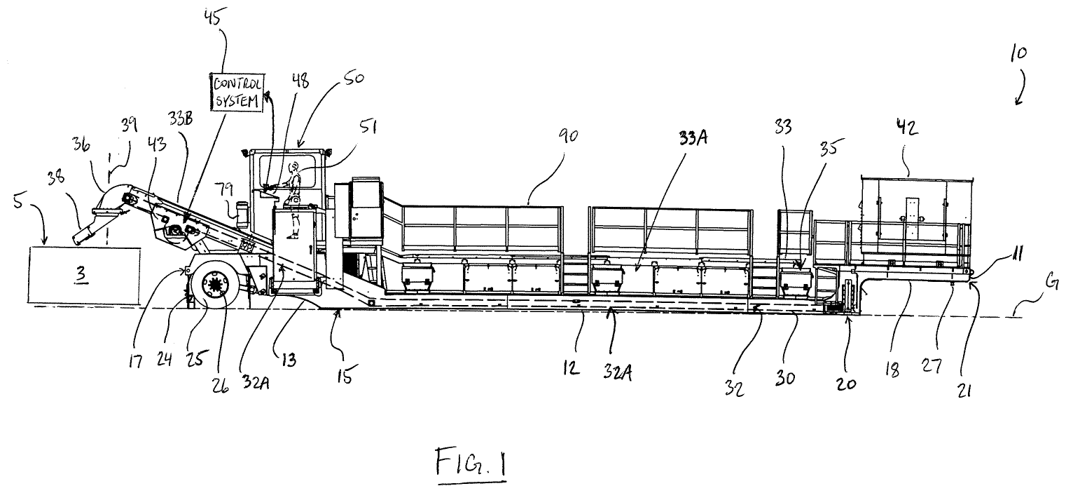

The portable conveyor apparatus 10 further includes a conveyor 30 (schematically shown in stippled line in FIG. 1) supported on the frame 11 that comprises a conveying member 32 in the form of a belt conveyor having a longitudinally extending conveyor belt and a plurality of longitudinally spaced rollers mounted to the frame 11 at least one of which is driven. The conveying member 32 is covered at least on a top side thereof by a conveyor housing 33, which includes an upper shell 33A mounted to the center frame section 12 to cover an intake portion 32A of the conveying member and a circumferentially enclosed tubular section 33B encompassing an inclined discharge portion 32B of the conveying member. The conveying member 32 is driven to transfer the proppant from an intake 35 of the conveyor to a discharge 36 of the conveyor, both of which are defined by the conveyor housing 33. In the illustrated arrangement, there are six intakes, three on each lateral side of the frame 11, which are closed by an openable access door. In use of the apparatus 10 to transfer the proppant as shown in FIGS. 2A and 2B, at least one of the intakes 35 is operatively communicated with a respective one of the storage containers 1 to receive the proppant therefrom, such as by retractable flexible ducts which are mounted to the conveyor housing 33 and respectively operatively connected to discharges of the storage containers. The single common conveyor discharge 36 which is fed by all of the intakes 35 is communicated with the blender 3 so as to transfer the proppant to the blender. The discharge 36 is located generally laterally centrally of the frame 11 and includes a chute 38 which is rotatable about a vertically upstanding axis 39 and receives the proppant from the conveying member 32 to guide the proppant by gravity for subsequent deposition at a target location, which is the blender 3.

The conveyor 30 is oriented generally longitudinally of the frame 11 so as to be operable to convey the proppant longitudinally of the trailer frame. The conveying member 32 comprises the intake portion 32A disposed along the center frame section 12 configured to receive material from the intakes 35 and the inclined discharge conveyor portion 32B disposed along the rear frame section rearwardly of the intake portion 32A, with the discharge 36 located at the rear end 17 of the frame. The intake portion 32A is operable to convey the particulate material received from the storage containers 1 in a direction longitudinally of the trailer frame 11 towards a rear of the intake portion 32A, and the discharge conveyor portion 33B is operable to receive the particulate material from the intake portion 32A and transfer the particulate material longitudinally of the trailer frame for discharge to the target location which in this case is the blender 3 located rearwardly of the frame 11. Generally speaking, the conveying member 32 of the illustrated arrangement is known in the art and thus not described in further detail herein.

A power pack 42 including generators is carried on the forward frame section 18 of the trailer frame and is operatively coupled to motors 43 for operating the conveying member 32 and to pumps of a suspension coupled to the wheel and axle assembly 24.

A conveyor control system 45 is operatively coupled to the drive motors 43 of the conveying member 32 for controlling the conveying member to transfer the proppant from the conveyor intake 35 to the conveyor discharge 36. For example, the control system 45 comprises a processor and a memory operatively coupled to the drive motors 43 which in turn drive rotation of at least one of the conveyor belt-supporting rollers so as to rotate the conveyor belt. The control system 45 includes a controller 48 to facilitate input of commands by an operator to operate the conveying member 32, for example speed of material transfer of the conveying member 32. Additionally the control system 45 may be configured to control flow of proppant out of the respective storage container 1, for example by opening and closing discharge gates of the storage container, to provide a reading of amount of proppant in the respective storage container which is being monitored, and to stop all operations related to the delivery of the proppant from the storage containers to the blender in case of an emergency. The conveyor controller 48 may be a fixed unit, such as in the form of a stationary pedestal, or a hand-held unit, with an interface for inputting the commands such as a touch screen interface or tactile buttons.

Thus the flow of proppant during preparation for use in the wellbore is from storage container(s) 1 to the conveying apparatus 10 which acts as a feed conveyor for the blender 3 where the proppant is mixed with other ingredients and, more generally, prepared for delivery to the wellbore. The operator 51 interfaces with the control system 45 to operate the conveying member 32 so that the proppant received by the conveyor 30 can be transferred to the blender 3.

As it is typically required for the operator to be positioned in proximity to the blender 3 to visually observe and monitor the interior thereof at 5, the portable conveying apparatus 10 includes an operator cab 50 for housing the operator 51 using the control system 45 to operate the conveying member 32. The cab 50 is mounted on the frame 11 so as to be portable therewith, and generally speaking is arranged so that the blender interior 5 where the proppant is prepared is visible to the operator 51 when located in the cab 50, as will be better appreciated shortly.

The operator cab 50 includes a substantially horizontal floor 52 which is supported above the frame 11 of the apparatus 10 at a suitable height by a framework of horizontally oriented beams 53 and upstanding posts 54. The floor 52 is connected to a topside of the beams 53 which beams are connected to upper ends 55 of the posts, and lower ends 56 of the posts are mounted to the frame 11.

The cab 50 also includes a four-sided peripheral wall 58 standing upwardly from the floor 52, with a rear side 59 of the peripheral wall 58 which is generally facing the rear end 17 of the frame terminating at its bottom end at a greater height than a remainder of the peripheral wall so as to accommodate the inclined discharge conveyor portion 32B. Thus, the floor 52 includes an inclined portion 61 which interconnects the rear side 59 of the peripheral cab wall 58 over the conveyor discharge portion 32B and a main horizontal portion 63 of the floor 52 over which the operator 51 is positioned most typically.

A cab door 66 is hingedly mounted in an entryway opening defined in the peripheral wall 58, so as to be arranged to define a selectively openable entryway into the operator cab, such that the door 66 is movable between open and closed positions so as to permit the operator 51 to pass into the cab through the entryway opening when the door is in the open position while also allowing the operator 51 to substantially seal the otherwise open entryway by placing the door 66 in the closed position so as to resist passage of air outside the operator cab 50 through the entryway into the cab 50. The door 66 is mounted in a front side 67 of the peripheral wall 58 which is generally facing the front end 21 of the frame.

Additionally there is provided a window 69 which is mounted in the peripheral wall 58 in a manner so that the interior 5 of the blender 3 is visible from inside the operator cab 50. That is, in the illustrated arrangement, the window 69 is rear-facing so as to be a rear-viewing window through which the blender 3 located rearwardly of the frame 11 is visible. Also, a bottom or sill of the window is spaced at a suitable height above the frame 11 so that the blender interior 5 may be visible, such that the window 69 is wholly located at a spaced height above the frame, as the cab 50 is located at a longitudinally spaced position from the rear frame end 17 so as to be set inwardly from the rear end 17 of the frame beyond which the blender 3 is located. This suitable height of the rear-viewing window 69 as well as the height of the cab floor 52 above the frame 11 are arranged at least based on the setback distance of the cab and may additionally accommodate for the height of apparatus equipment disposed generally intermediate the cab 50 and the conveyor discharge 36, so as to provide the operator 51 with a viewing position having an uninterrupted line of sight to the blender interior 5 over the rear frame section 13 and any portion of the portable conveying apparatus 10 disposed on the rear frame section 13 in an otherwise potentially visually obstructive position. Furthermore, the cab 50 with the blender-viewing window 69 provides the viewing position from inside the cab 50 which is laterally offset from the conveyor discharge 36 so that the view of the blender interior 5 is substantially unobstructed by the discharge 36. The operator cab 50 as a whole has a width between laterally opposite sides of the peripheral wall 58, which sides are spaced apart in a lateral or width direction of the frame 11, that is smaller than the width of the frame 11 between its laterally opposite sides, so that the cab is located closer to one of the lateral sides of the frame 11 than the other in order to provide the laterally offset viewing position. The cab 50 is also located closer to the rear end 17 of the frame than the front end 21, so as to improve visibility of the blender interior 5.

Additionally to the discharge and blender-facing window 69, the operator cab 50 also includes left and right side windows 72, 73 so as to improve operator visibility of his/her work environment aside from just the blender 3.

Furthermore, the operator cab 50 includes a ceiling 75 closing a top of the peripheral wall 58. The ceiling 75 is defined by at least one sheet-like panel 76 which individually spans or collectively span a top opening defined by a top edge of the peripheral wall 58 that is otherwise present if there is no like component as the panel 76. The at least one ceiling panel 76 is exposed to the outside of the cab 50.

Thus, the cab floor 52, the peripheral cab wall 58, the cab ceiling 75 and the door 66 of the operator cab collectively form a substantially enclosed space which restricts passage of air outside the operator cab into the operator cab. Each adjacent set of components of the operator cab 50 such as the ceiling 75 and the peripheral wall 58, the peripheral wall 58 and the floor 52, and the peripheral wall 58 and the windows 69 and 72, 73, and the peripheral wall 58 and the door 66 and the floor 52 are either interconnected or arranged so as to form a substantially air-tight seal to restrict passage of the outside air which during operation of the conveying apparatus 10 is likely to carry silica dust which is hazardous to the operator 51.

In order to provide the operator 51 with clean, breathable air within the operator cab 50, the cab 50 includes an air filtration system 79 which is adapted to permit passage of air which is free of silica dust between the outside and the inside of the operator cab 50. The filtration system 79 is fluidically communicated with the inside of the cab 50 and the outside of the cab 50 to draw ambient air from outside the cab 50, remove the silica dust and other particulate debris in the air, and pass the cleaned air to the inside of the cab 50, the oxygen of which the operator 51 can consume without inhaling other foreign airborne particulate matter and particularly silica dust. As the operator 51 who is housed inside the closed cab 50 continually breathes and consequently expels carbon dioxide as part of the breathing cycle, the filtration system 79 also removes air from inside the cab and passes the same to the outside of the cab so that there is continual circulation of fresh air free of silica dust inside the operator cab 50.

Generally speaking, the air filtration system 79 comprises an ambient air intake which is adapted to draw in the ambient air which is outside the operator cab 50, a filter which is in fluidic communication with the ambient air intake and adapted to remove particulate matter including silica dust from the ambient air which has been drawn in, and a filtered air discharge disposed inside the cab 50 for delivering the filtered air to the operator 51 in the cab 50. The filtration system 79 additionally includes a return vent disposed inside the cab for drawing air from inside the cab so as to provide air circulation. Suitable filtration systems are known in the art and thus not described in further detail herein.

Additionally, the filtration system 79 is adapted to pressurize the interior of the cab 50 to form an air pressure gradient between the inside and the outside of the cab 50 with greater air pressure inside than outside of the cab so as to resist inadvertent passage of particulate material or debris such as silica dust from outside the cab 50 and into same, and to expel any such particulate matter which has inadvertently entered the cab 50 by conveying such matter back to the outside of the cab 50. Thus, any dust particles or other debris which might inadvertently enter the cab 50 when the door is opened or through small openings such as through leaky seals at a window or door is pushed out of the cab.

In order to enable the operator 51 to work from inside the operator cab 50, the controller 48 of the conveyor control system 45 is located in the substantially enclosed space of the cab 50 for interfacing with the control system 45 to operate the conveying member 32. The controller 48 is positioned along the rear side 59 of the peripheral wall 58 so that the operator can interface with the controller 48 without moving from the viewing position within the cab. Thus, the interior of the cab 50 provides dust-free work environment with a suitable viewing position and the equipment which the operator 51 uses to carry out his/her function within the hydraulic fracturing operation.

It will be appreciated that even though the portable conveying apparatus 10 can be originally manufactured with the operator cab 50, in some arrangements the operator cab 50 may be defined by a kit of assemblable parts which are connectable to the frame 11 of the portable conveying apparatus which was originally manufactured at a manufacturing facility without the operator cab, and therefore previously excluded the operator cab. This kit for retrofitting an existing portable conveying apparatus with an operator cab as that disclosed herein includes all the same components as the illustrated arrangement, meaning that the illustrated arrangement of operator cab is designed to be an assemblable kit which can be added to an existing conveyor without substantial modification of same. The kit may include extension cables to relocate the existing controller of the apparatus in the operator cab at a position which is suitable for simultaneous viewing of the blender and controller-interfacing and/or the kit may include an auxiliary controller which is configured to communicate with the existing controller to operate as an extension of the existing controller or to communicate with the existing control system as an alternative controller.

In the illustrated arrangement the operator cab 50 also includes an externally mounted spotlight 83 connected to the rear side 59 of the peripheral wall 58 above the blender-viewing window 69 and facing rearwardly towards the blender 3 such that the spotlight is oriented so as to illuminate the interior 5 of the blender 3. The spotlight 83 is also mounted at a laterally offset position from the discharge of the conveyor so as to provide an illumination area which is substantially unobstructed by the conveyor discharge 36. In this regard, the spotlight 83 is located on the rear side 59 of the peripheral 58 at a farthest lateral position from the lateral center of the frame 11. There is also provided a second spotlight 84 on a front entrance side of the operator cab 50.

In conjunction with the operator cab 50 there is provided outside thereof a landing platform 85 adjacent the cab door 66 and a ladder 86 at an edge of the landing platform depending downwardly therefrom to enable the operator 51 to climb into the cab 50 at its raised height above both the frame and the ground. An openable gate 87 and railing 88 is provided about a periphery of the landing platform to prevent falls therefrom.

Referring back to FIG. 1, the apparatus 10 also includes a catwalk 90 mounted to the conveyor housing 33 and located over the center frame section 12 which interconnects with the landing platform 85. The catwalk 90 extends longitudinally of the center frame section 12 to allow the operator to readily move across the portable conveying apparatus 10, whether from one of the intakes 35 to the power pack 42 to the operator cab 50, without having to circumnavigate the apparatus 10 on the ground.

The scope of the claims should not be limited by the preferred embodiments set forth in the examples but should be given the broadest interpretation consistent with the specification as a whole.

1. A portable conveying apparatus for use in a hydraulic fracturing operation to transfer proppant from one or more storage containers storing said proppant to a blender where the proppant is prepared for subsequent delivery to a hydraulic fracturing wellbore, in combination with the one or more storage containers and the blender, the portable conveying apparatus comprising:
a frame;
a plurality of wheels mounted on the frame for rotation about respective wheel axes so as to support the frame in movement across a ground surface;
a hitch coupling attached to the frame so that the frame is towable across the ground surface by a transport vehicle;
a conveyor supported on the frame and having a conveying member driven to transfer the proppant from an intake of the conveyor to a discharge of the conveyor, the intake being operatively communicated with the one or more storage containers to receive the proppant therefrom and the discharge of the conveyor being communicated with the blender so as to transfer the proppant to the blender;
a control system which is operatively coupled to the conveyor for controlling the conveying member to transfer the proppant from the intake to the discharge;
an operator cab mounted on the frame so as to be portable therewith for housing an operator using the control system to operate the conveying member;
the operator cab being arranged so that an interior of the blender where the proppant is prepared is visible to the operator when located therein;
the operator cab including:
a floor;
a peripheral wall standing upwardly from the floor,
a ceiling closing a top of the peripheral wall;
a door arranged so to define a selectively openable entryway into the operator cab to enable the operator to pass from outside the operator cab into the operator cab;
a window mounted in the peripheral wall in a manner so that the interior of the blender is visible from inside the operator cab;
whereby the floor, the peripheral wall, the ceiling and the door of the operator cab collectively form a substantially enclosed space which restricts passage of air outside the operator cab into the operator cab;
the operator cab including an air filtration system adapted to permit passage of air which is free of silica dust between the outside and the inside of the operator cab;
the operator cab further including a controller of the control system located in the substantially enclosed space for interfacing with the control system to operate the conveying member.

2. The portable conveying apparatus of claim 1 wherein the air filtration system is adapted to pressurize the operator cab to form an air pressure gradient between the inside and the outside of the operator cab with greater air pressure inside the operator cab than outside of the operator cab so as to be suited for expelling particulate material out of the operator cab.

3. The portable conveying apparatus of claim 1 wherein the frame has longitudinally opposite ends and laterally opposite sides, and wherein the window is located at a laterally offset location from a lateral position of the discharge of the conveyor relative to the frame.

4. The portable conveying apparatus of claim 1 wherein the frame has longitudinally opposite ends and laterally opposite sides, and wherein the cab is located at a laterally offset location from a lateral position of the discharge of the conveyor relative to the frame.

5. The portable conveying apparatus of claim 1 wherein the frame has longitudinally opposite ends and laterally opposite sides, and wherein the discharge of the conveyor is located generally laterally centrally of the frame and the operator cab, which is smaller in width than a width of the frame between the laterally opposite sides thereof, is located closer to one of the lateral sides of the frame than the other.

6. The portable conveying apparatus of claim 1 wherein the frame has longitudinally opposite front and rear ends, the hitch coupling is located at the front end and the discharge of the conveyor is located at the rear end, and the operator cab is located on the frame at a longitudinally spaced position from the rear end of the frame.

7. The portable conveying apparatus of claim 6 wherein the floor of the operator cab is spaced above the frame and arranged at a suitable height for the operator standing thereon to see over the frame and beyond the rear end of the frame.

8. The portable conveying apparatus of claim 1 wherein the operator cab is formed by a retrofit kit of parts connected to the frame of the portable conveying apparatus after manufacture of the portable conveying apparatus at a manufacturing facility.

9. The portable conveying apparatus of claim 1 wherein the operator cab further includes an externally mounted spotlight which is oriented so as to illuminate the interior of the blender.

10. The portable conveying apparatus of claim 9 wherein the spotlight is mounted at a laterally offset location from a lateral position of the discharge of the conveyor relative to the frame.
